(19) United States
(12) Patent Application Publication
(10) Pub. No.: US 2020/0256413 A1
(43) Pub. Date: Aug. 13, 2020

(54) Cold Worked Steel Brake Piston For A Motor Vehicle Partially Lined Disc Brake

(71) Applicants: Continental Teves AG & Co. OHG, Frankfurt (DE); Erdrich Umformtechnik GmbH, Renchen-Ulm (DE)

(72) Inventors: Thomas Winkler, Mainz (DE); Dieter Füller, Nauheim (DE); Uwe Zeibig, Achern (DE); Matthias Müller, Oberkirch (DE)

(21) Appl. No.: 16/651,882

(22) PCT Filed: Oct. 2, 2018
(86) PCT No.: PCT/EP2018/076715

§ 371 Date: Mar. 27, 2020

(30) Foreign Application Priority Data
Oct. 10, 2017 (DE) 10 2017 218 027.7

(51) Int. Cl. F16D 65/18; B23P 15/10

(52) U.S. Cl. CPC F16D 65/18; F16D 2121/04; B23P 15/10

(57) ABSTRACT

The invention relates to a cold-formed steel brake piston 1 for a motor vehicle partial-pad disc brake brake pad with a thin-walled structure as a cup open at one end and comprising a base 2 and a wall 3 with a radially outwardly impressed groove 6 in the wall 3 and with a radially inwardly impressed wall projection 7.

The invention has the object of providing a further improved stable steel brake piston construction with an improved interface which can be used flexibly and cost-effectively for both large-bore and small-bore steel brake pistons 1.

This object is accomplished by making the wall 3 with at least one groove 14 and at least one land 15 at a distance from wall projection 7 profiled in such a way that wall 3 has wall surface areas of varying thickness which are spaced apart from each other in the circumferential direction with a spacing V.

The invention relates to a cold-formed steel brake piston for a motor vehicle partial-pad disc brake brake pad, with a thin-walled structure as a cup open at one end and comprising a base and a wall, with a radially outwardly impressed groove in the wall, and with a radially inwardly impressed wall projection on the wall.

A particularly stable and deep-drawn piston with a dome-shaped head is for example known from EP 304 103 A1. One disadvantage of pistons with a particularly weight-optimized, thin-walled design is that their walls have a minimized wall thickness, so that they bulge under stress, i.e. can give rise to buckling. Possible consequential damage includes leakage, increased wear and consequential damage such as seizure or jamming of the wall in a piston bore. Consequently a particularly light, stable, inexpensive and rotationally symmetrical steel brake piston of wall thickness A, manufactured without machining, is known from U.S. Pat. No. 4,193,179 B1. An annular groove is rolled in from radially outside at the open end of the wall, at right angles to the piston longitudinal axis.

The object of the invention is to provide a further improved stable steel brake piston construction with an improved interface, equally suitable for both large-bore and small-bore steel brake pistons and scaled for cost-effective production.

According to the invention this object is accomplished by constructing the wall with a space next to the wall projection, i.e. at the open end of the cup, with at least one groove and at least one land profiled in such a way that the wall has wall surface areas of varying thickness arranged at a distance from one another in the circumferential direction. Thus there is a special inner wall profile, so that the piston wall has wall areas of varying thickness with a largely smooth cylindrical outer wall. Advantageously the groove and land alternate parallel to the piston axis and parallel to each other on the circumference with different diameters (top circle, base circle). For example, two parallel grooves may share two parallel lands, the grooves and lands alternating intermittently on the inner circumference parallel to the axis of the piston. Through its inner profile and the variation in wall thickness the brake piston wall therefore differs from piston walls ideally having the same thickness. The invention has the advantage that guidance of the piston outer wall is unaffected, and that the grooves and lands reduce cycle time during brake bleeding through a channel-like action, because, for example, air bubbles escape in a channeled way.

Basically, it is possible to arrange grooves and lands opposite each other. This advantageously prevents irregular bending of the piston wall.

The profile of the transition between grooves and lands may be of any shape and may for example be a stepped shoulder. Other shapes of transitions between grooves and lands may be possible. Particularly advantageous results may be achieved, for example, with grooves and lands impressed in wave-like or tooth-like profiles, where the buckling resistance of the piston wall increases disproportionately with increased radial overlap. Generous rounding or rounding in a transition area between grooves and lands, i.e. especially in the transition area between the top circle and base circle, reduces a notch effect.

In principle, the profiles of the grooves and lands may be symmetrical in cross-section, which can facilitate machine finishing and quality control. Both positionally correct assembly arrangement for peripheral components and any additional functions can be enabled through asymmetrically distributed or otherwise arranged profiling. For example, the profiling between the inner piston wall and peripheral components may be effective as an interlocking anti-rotation measure.

A further embodiment of the invention comprises the inner wall of the piston having several lands, with the lands essentially arranged diametrically opposite each other. As a result their reinforcing effect is distributed particularly efficiently over the circumference of the piston wall at lower cost.

With all the lands regularly spaced, and possibly extending over the entire inner circumference of the piston inner wall, for example, the reinforcing effect described is effectively evenly distributed over the entire wall. A larger proportion of lands has an inherent positive volumetric bonus effect. This also reduces the free hydraulic volume within the piston. As a result the necessary volume of brake fluid is reduced without the need for separate displacement elements.

In principle, all grooves or lands may be provided with identical profiles, which facilitates machining with swaging dies, mandrels or similar tools. In order to develop a value-added function, it is possible to automatically design a correct assembly arrangement to favorably pair assembly of the piston with peripheral components through providing grooves or lands having different profiles in a special pattern so that they can be assembled in particular positions exclusively aligned with each other. In principle, the special pattern may include a specific variation in all the geometrical parameters of the grooves and lands (depth, length, spacing, offsetting, relationships with each other and the inner wall of the piston). In this way, and through a correspondingly targeted incorporation of the grooves and lands in a peripheral component, a structurally positionally correct blueprint for positionally correct assembly becomes a possibility. It should be added that the peripheral component may, for example, be a nut of a spindle-nut system for a parking brake or a nut in a friction lining wear adjustment device.

In order to achieve a bonus effect, the lands may take the form of upstanding interlocking radially inward facing anti-rotation means on the piston inner wall in such a way that they positively engage in a cavity in a matching counterpart. The opposite also applies to grooves. This establishes a non-rotating interlocking connection between the piston and the peripheral part, which may for example be a nut on a spindle system for a parking brake device.

Further advantageous features, effects and embodiments of the invention may be seen in detail from the following description based on the appended drawing. In the drawing:

FIG. 1 shows a small-bore steel brake piston in reduced perspective view,

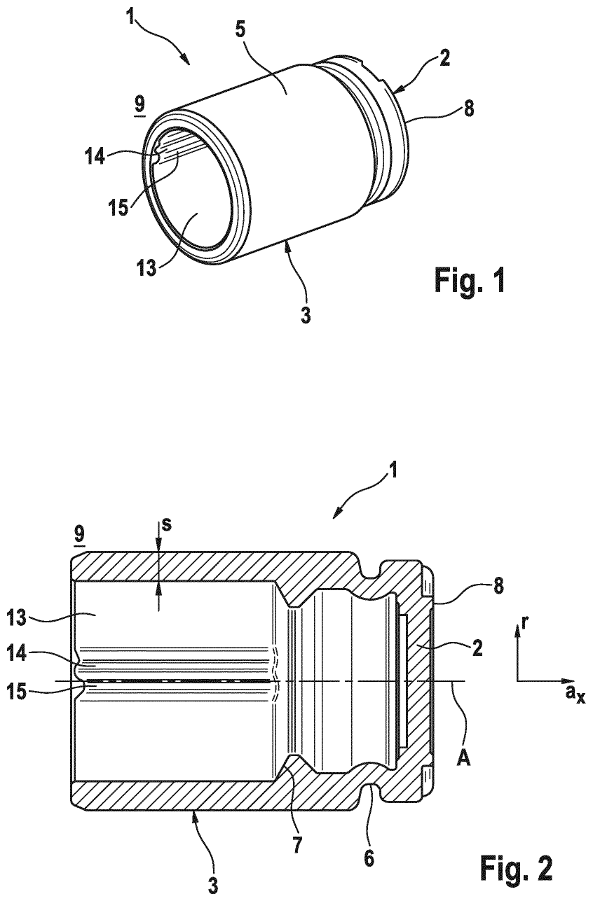

FIG. 2 shows a small-bore steel brake piston in magnified cross-section,

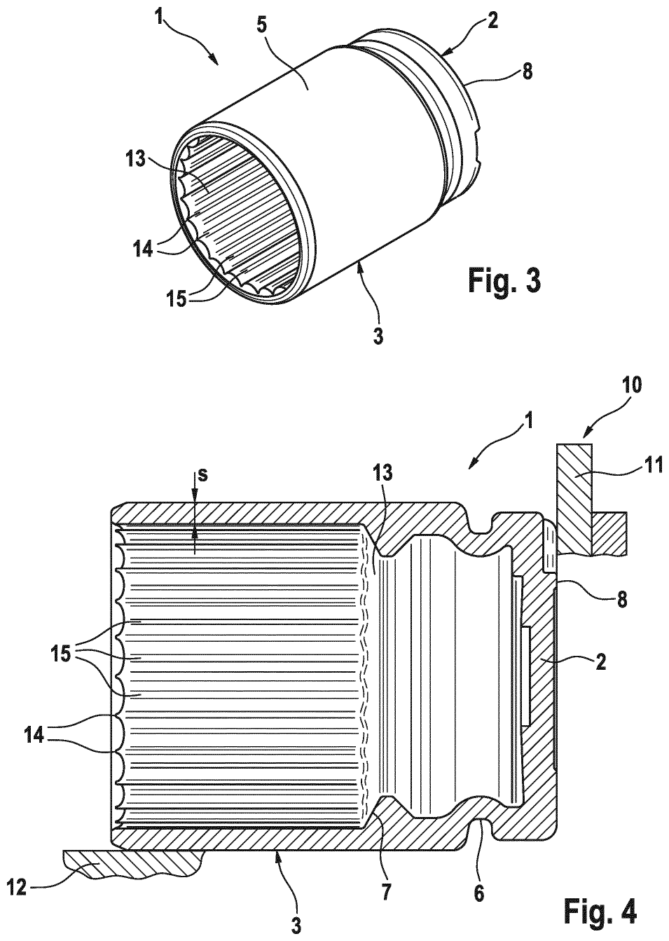

FIG. 3 shows a large-bore steel brake piston in reduced perspective view,

FIG. 4 shows a large-bore steel brake piston in magnified cross-section,

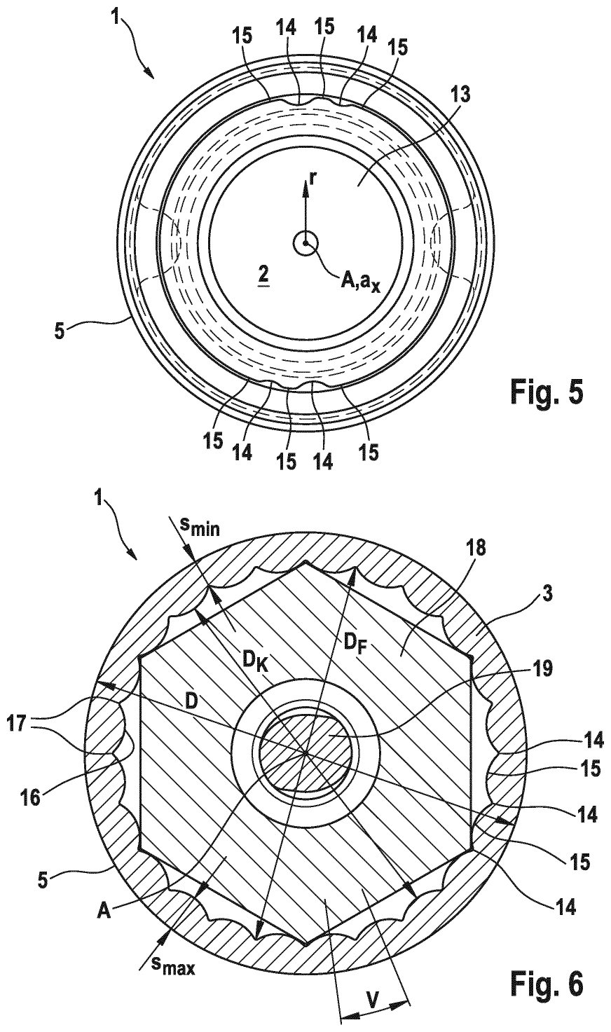

FIG. 5 shows a small-bore steel brake piston according to FIG. 2 in magnified plan view from the left,

FIG. 6 shows a piston module containing a large-bore radiate brake piston as in FIG. 4 in plan view from left with parking brake components inserted, in magnified view, and

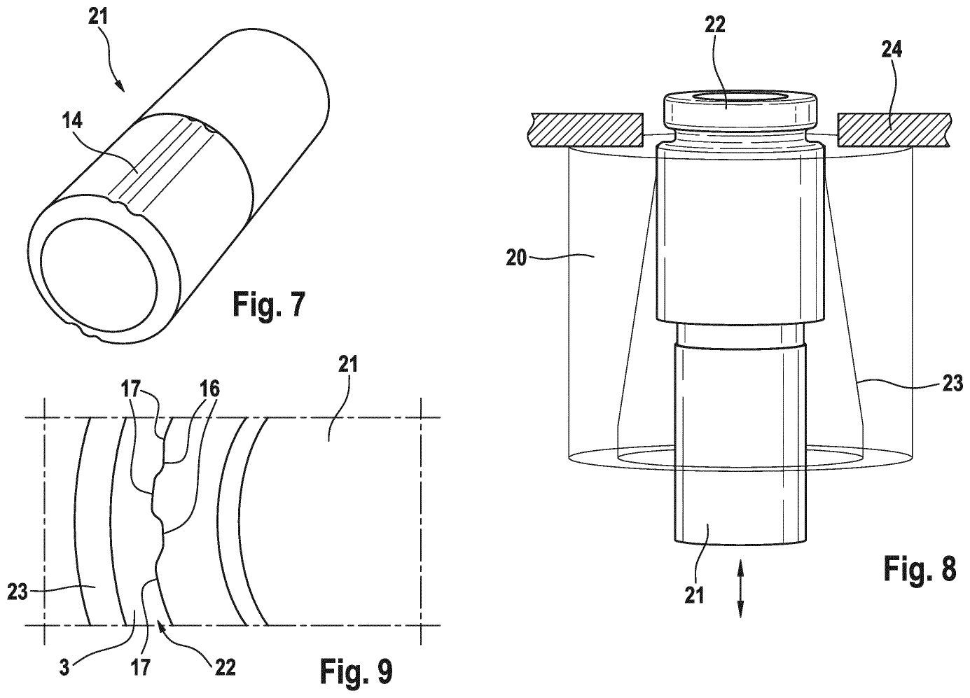

FIG. 7-9 show outline sketches to explain the steel brake piston manufacturing process.

The invention relates to a thin-walled, cold-formed, one-piece steel brake piston 1 for a hydraulic disc brake in the form of a cup open at one end comprising a base 2 and a wall 3 incorporating inner and outer walls 4,5. The wall thickness s is largely constant over base 2 and wall 3. The nominal piston diameter D and the wall are as far as possible rotationally symmetrical parallel to the longitudinal axis A of the piston. The outer wall 5 may have a radially inwardly impressed groove 6 at the end or base, which is open radially outwards. A wall projection 7 may be provided radially inside, for example in the vicinity of groove 6 or axially offset from it. Wall projection 7 may have an annular circumferential shape, i.e. it may contribute to a local strengthening effect through reinforcement of the cross-section, including work hardening, to avoid local stress concentration. Radiate brake piston 1 has a support for interaction with a friction lining back plate 11 of a partial-pad disc brake brake pad 10 at its open end 9, or at its base 2. This support is arranged as a largely flat end face 8 at right angles to the longitudinal axis A of the piston. The inside 13 of the piston may incorporate interfaces for the arrangement of or interaction with peripheral components. For example, wall projection 7 may be used as an interface for the following functions: a) for introducing a locking force, b) for fixing between back plate 11 and steel brake piston 1, or inner wall c) as a support for springing for the friction lining, d) anti-rotation device for a nut 18 of a locking device.

In accordance with the invention, inner wall 4 has laterally at the open end, possibly at a distance from wall projection 7, at least one groove 14 and at least one land 15 profiled so that wall 3 has alternating wall surface areas of different thicknesses spaced apart from one another in the circumferential direction with a spacing V. Through the alternating variation in cross-section, together with work hardening, as well as through functional interaction with wall projection 7, grooves 14 and lands 15 can thus contribute to a local strengthening effect, that is avoidance of local stress concentrations and consequently avoid undesired deformation of wall 3. In this context, each groove 14 is present as a radially outwardly directed and axially extending cavity parallel to axis A of the piston, that is a reduction in wall thickness. By contrast, each land 15 is to be understood to be a radially inwardly orientated, i.e. locally thickened, wall reinforcement extending axially parallel to axis A of the piston. Grooves 14 and lands 15 are parallel to each other. Grooves 14 and lands 15 are alternately located on inner wall 4 with diameters spaced apart (top circle DK, base circle DF). Their spacing V is preferably at regular intervals so that alignment for mounting peripheral components can be made as simple as possible. However, grooves 14 and lands 15 may also be staggered irregularly on inner wall 4 if a special arrangement is required. Grooves 14 and lands 15 may be identical to each other and may be specially profiled. However an interlocking arrangement is also possible in this respect, in which grooves 14 and lands 15 are each provided with different profiles so that peripheral components can be correctly positioned in a unique assembly position. The arrangement may be imposed by the fact that grooves 14 or lands 15 are arranged in relation to each other according to a certain pattern at the circumference.

One function of grooves 14 and lands 15 may be that they are arranged to form an interlocking anti-rotation device so that they act together with a matchingly profiled counterpart on a peripheral component (nut 18 of a spindle nut system). The profile of inner wall 4 may form a spline hub segment or may be in the form of an annular enclosing spline hub profile. Several grooves 14 are provided in pairs diametrically opposed to each other, and accordingly several lands 15 are provided in pairs diametrically opposed to each other. In the transition between groove and land the profile formed may include a flank profile having a stepped shape. Deviations from the step shape are possible. For example, the flank profile between groove 14 and land 15 may be wave-shaped or toothed. In order to permit free movement or appropriate tolerance the flank profile is rounded 16 on the top circle side and beveled 17 on the base circle side in the transition between groove 14 and land 15. Tool manufacture is simplified when grooves 14 and lands 15 are constructed with symmetrical cross-sections. Grooves 14 and lands 15 may be asymmetrically distributed or arranged to allow for the correct positioning of peripheral components. Additionally grooves 14 and lands 15 on the inside of piston 13 may be used as an interlocking as well as a rotationally fixed receptacle for matching grooves and lands on a profiled nut 18 of a spindle system for a parking brake device.

The profiling is produced according to FIG. 7-9 by means of a perforated die 20 fixed in the working area in a stationary position on a table 24 in conjunction with an externally profiled forming ram 21 which cyclically makes its working strokes in the direction of die 20. The externally profiled forming ram 21 engages the inside 13 of a cup-shaped piston blank 22 and draws piston blank 22 through a hole 23 in die 20 (i.e. drawing and ironing). Alternatively, solid forming (reverse extrusion using a cup-shaped die and an externally profiled ram) is possible.

### LIST OF REFERENCES

1 Steel brake piston
2 Base
3 Wall
4 Inner wall
5 Outer wall
6 Groove
7 Wall projection
8 Front end surface
9 Open end
10 Partial-pad disc brake brake pad
11 Friction lining back plate
12 Brake housing
13 Inside of piston
14 Groove
15 Land
16 Rounding off
17 Bevel
18 Nut
19 Spindle
20 Die
21 Forming ram
22 Piston blank
23 Hole
24 Table
A Longitudinal axis of piston
ax Axial direction
D Nominal piston diameter
DK Top circle diameter
DF Base circle diameter
r Radial direction
s Wall thickness
smin Minimum wall thickness
smax Maximum wall thickness
V Spacing

1. A cold-formed steel brake piston for a motor vehicle partial-pad disc brake brake pad having a thin-walled structure in the form of a cup open at one end and comprising a base and a wall, with a radially outwardly impressed groove in the wall, and with a wall radially inwardly impressed projection on the wall, wherein the wall is formed with at least one groove and at least one land spaced apart beside the wall projection and profiled in such a way that the wall has areas of wall of different thickness having a spacing V apart from one another in the circumferential direction.

2. The cold-formed steel brake piston according to claim 1, wherein a plurality of grooves and a plurality of lands are provided, each parallel to each other and in an axial direction.

3. The cold-formed steel brake piston according to claim 1, wherein the grooves and the lands are each directed parallel to axis A of the piston.

4. The cold-formed steel brake piston according to claim 1, wherein the grooves and the lands are arranged alternately with diameters (DK, DF) spaced apart on the circumference of the inner wall.

5. The cold-formed steel brake piston according to claim 1, wherein the grooves and/or the lands are arranged at a distance from one another on the inner wall with a regular spacing (V).

6. The cold-formed steel brake piston according to claim 1, wherein the grooves and/or the lands at an irregular spacing (V) from each other are arranged at a distance from each other on the inner wall.

7. The cold-formed steel brake piston according to claim 1, wherein the grooves and the lands are constructed in a profiled manner.

8. The cold-formed steel brake piston according to claim 1, wherein the grooves or the lands have profiles that are identical to each another.

9. The cold-formed steel brake piston according to claim 1, wherein the grooves or the lands have profiles that differ from one another.

10. The cold-formed steel brake piston according to claim 1, wherein the grooves or the lands are spaced in relation to each other at the circumference according to a certain pattern.

11. The cold-formed steel brake piston according to claim 1, wherein the grooves and the lands are arranged so as to form an interlocking anti-rotation means in a way that they act together with a matchingly profiled counterpart on a peripheral component.

12. The cold-formed steel brake piston according to claim 1, wherein the grooves and the lands are alternately arranged as a splined hub profile.

13. The cold-formed steel brake piston according to claim 1, wherein a plurality of grooves are provided in pairs diametrically opposed to each other and wherein a plurality of lands are provided in pairs diametrically opposed to each other.

14. The cold-formed steel brake piston according to claim 1, wherein a flank profile between the groove and the land has a stepped shape.

15. The cold-formed steel brake piston according to claim 1, wherein a flank profile between the groove and the land is designed to be wave-shaped or toothed.

16. The cold-formed steel brake piston according to claim 1, wherein a flank profile in the alternating transition between the groove and the land is rounded on the top circle side and a bevel on the base circle side.

17. The cold-formed steel brake piston according to claim 1, wherein the groove and the land are of symmetrical or asymmetrical shape in cross-section.

18. The cold-formed steel brake piston according to claim 1, wherein the grooves and the lands are asymmetrically distributed or arranged in order to enable correct assembly positioning of a peripheral component.

19. The cold-formed steel brake piston according to claim 1, wherein the grooves and the lands are provided on the inside of the piston as an interlocking and rotationally fixed receptacle for matching grooves and lands on a profiled nut of a spindle system for a parking brake device.
